(19) United States
(12) Patent Application Publication
(10) Pub. No.: US 2013/0232024 A1
(43) Pub. Date: Sep. 5, 2013

(54) Live Online Auction

(71) Applicant: Nicholas N. Nassiri, Inglewood, CA (US)

(72) Inventor: Nicholas N. Nassiri, Inglewood, CA (US)

(21) Appl. No.: 13/784,554

(22) Filed: Mar. 4, 2013

Related U.S. Application Data
(60) Provisional application No. 61/606,270, filed on Mar. 2, 2012.
(60) Provisional application No. 61/648,910, filed on May 18, 2012.

(51) Int. Cl. G06Q 30/08

(52) U.S. Cl. CPC G06Q 30/08
USPC 705/26.3

(57) ABSTRACT

An auction system and software are provided for performing a live, real-time auction over the internet. The auction software includes a graphical user interface for an auctioneer to administer various functions of the auction. The auction software also includes a graphical user interface for a bidder to allow participation and bidding for various auction items.

### RELATED APPLICATIONS

This application is the non-provisional of and claims priority to U.S. Provisional Application Ser. No. 61/648,910 filed May 18, 2012 entitled Live Online Auction Interface, and U.S. Provisional Application Ser. No. 61/606,270 filed Mar. 2, 2012 entitled Live Online Auction, both of which are hereby incorporated herein by reference in their entireties.

### BACKGROUND OF THE INVENTION

It can be appreciated that various methods of auction have been in use for years. Prior to the advent of on-line or Internet auctions, traditional auctions conventionally took the form of a physical gathering of participants assembled together within a specified location; said location being where the goods to be auctioned physically resided. At such traditional auctions, a human auctioneer was the conductor of the auction and the individual responsible for shilling the goods to the auction participants. Incited by the direction of the human auctioneer, bidding was conducted simultaneously, successively and competitively among a group of participants present at the auction site.

As noted above, the presence, participation, and personality of the auctioneer was an essential component that provided the auction its sense of competitiveness and excitement. The auctioneer was responsible for instigating bids from auction participants and increasing the bid amount in succession by cajoling the auction participants, and closing the auction upon a cessation of bidding. Thus, in the traditional auction, the role of the auctioneer was not only essential to the functioning of the auction, but in generating the excitement and enjoyment of the auction participants.

The threat of immediate, rapid-fire, and constant competition from other participants was a key factor in the auction's thrill and in the ability of the auctioneer to drive up the current bid price. Thus, in the traditional form of auction, the threat of immediate, rapid-fire bid input, constant competition, the solicitation and offering of goods by an auctioneer, are essential.

The advent of electronic commerce, the Internet, and its related technologies, dramatically and profoundly changed the nature and the method of the traditional auction. The Internet and its related technologies have liberated the bidder from having to be being physically present at the auction. Likewise, the corollary is that the Internet and its related technologies permit the auction of goods from locations that are geographically remote from the bidders. To state the obvious: the Internet has been instrumental in forging a new electronic marketplace that allows buyers and bidders to unite without regard to the constraints of geographical boundaries.

### SUMMARY OF THE INVENTION

One aspect of the present invention includes a streaming bid display region which includes a generally rectangular graphical area that displays a unique bidder identification adjacent to an auction bid amount. The unique bidder identification is associated with a bidder and their user account. The streaming bid display preferably displays the highest, current bid, along with several of the previous bids.

Another aspect of the present invention includes an auction floor interface 134 that provides a plurality of suggested bid graphical button elements that are associated with percentages lower than 100%. When the auctioneer presses one of these suggested bid buttons, a reduced suggested opening bid is transmitted out by the auction software to the webpage of online bidders for the auction. This allows the auctioneer to progressively reduce the suggested opening bid until the “bid floor” has been determined by the first, opening bid. After a predetermined number of suggested bid buttons have been pressed by the Auctioneer or when a predetermined button has been pressed (e.g., the last or bottom suggested bid button), the auction software repopulates the buttons with new, lower percentage values, which thereby allow the auctioneer to further reduce the suggested opening bid value.

In another aspect of the present invention, an interface is provided to the auctioneer to contact the seller with one of several predetermined requests while an auction is being conducted. Specifically, the interface includes a button element to transmit a request to the seller to remove the reserve from an auction item, reduce the reserve by a determined amount, and accept a highest bid that is under the reserve. A similar bidder interface allows the bidder to accept or modify any of these requests by the auctioneer.

In another aspect of the present invention, a bidder interface is provided, having a brand logo area or webpage background that is predetermined and uploaded by a seller of an action item. In this respect, the seller can customize a bidder's interface with brand logos and/or other custom designs while a particular auction item is being auctioned.

Another aspect of the present invention provides a custom bid interface that generates a window displaying a text box that allows input of a specific bid amount. The auction software will round the entered number to the nearest bid increment previously determined by the auctioneer. For example, if the Auctioneer previously determined that all bid increments will be in 10% increments, the custom bid will be rounded up or down to the nearest 10% increment. Additionally, the custom bid interface provides a plurality of button elements with predetermined percentages greater than 100%. When selected, these button elements submit a bid amount that increases the current asking bid increase by the button's percentage. For example, if the auctioneer asks for a bid of $10 higher than the current highest bid level, the 200% button element submits a bid of $20 (i.e., $10 multiplied by 200%). Hence, a bidder can quickly make a larger bid, if desired.

Another aspect of the present invention includes an auctioneer selection interface which provides a sample video of an auctioneer, their expertise and other professional details, and a selection element for requesting that this auctioneer perform the auction for a specific auction item. The auction software notes this request and groups and/or schedules an auctioneer accordingly.

### BRIEF DESCRIPTION OF THE DRAWINGS

These and other aspects, features and advantages of which embodiments of the invention are capable of will be apparent and elucidated from the following description of embodiments of the present invention, reference being made to the accompanying drawings, in which

FIG. 1 illustrates an auction system for performing a live, online auction with an auctioneer and one or more bidders;

FIG. 2 illustrates a graphical user interface for an auctioneer to administer an auction;

FIG. 3 illustrates a graphical user interface for an auctioneer to make predetermined requests to a seller during an auction;

FIG. 4 illustrates a graphical user interface for a seller to respond to request from an auctioneer during an auction;

FIG. 5 illustrates a graphical user interface for a bidder to participate in an online auction;

FIG. 6 illustrates a graphical user interface for a bidder to submit custom or predetermined bids;

FIG. 7 illustrates a graphical user interface for a seller for selecting a specific auctioneer to auction a seller's auction item; and,

FIG. 8 illustrates a flow chart of an example method for administering an auction.

### DESCRIPTION OF EMBODIMENTS

Specific embodiments of the invention will now be described with reference to the accompanying drawings. This invention may, however, be embodied in many different forms and should not be construed as limited to the embodiments set forth herein; rather, these embodiments are provided so that this disclosure will be thorough and complete, and will fully convey the scope of the invention to those skilled in the art. The terminology used in the detailed description of the embodiments illustrated in the accompanying drawings is not intended to be limiting of the invention. In the drawings, like numbers refer to like elements.

Some background and other details with regard to the present invention may be found in U.S. Pat. No. 8,036,949, the contents of which are hereby incorporated by reference herein. Various different terminologies are used in this specification which relates to graphical user interface elements, such as buttons, elements, regions, areas, media, and windows. It should be understood that these and other terminology refer to graphics that are displayable on a display screen and that can interacted with (e.g., via touch screen, mouse and/or keyboard) or associated with other graphical elements that can be interacted with by a user. It should also be understood that the auction software may be located and executed on the storage device/medium of a single server or may have separate portions distributed on various servers that interact with each other.

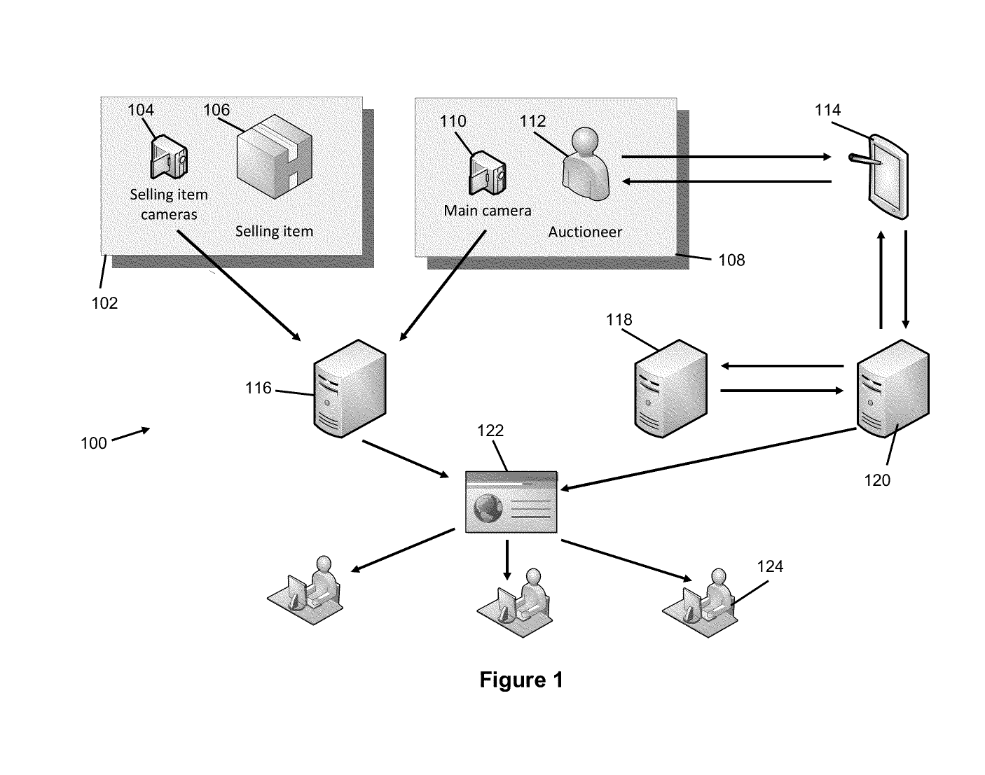

FIG. 1 illustrates an online, real-time auction system 100 according to the present invention. Generally, the auction system 100 allows a human auctioneer conduct a real-time auction (i.e., an auction typically spans several minutes instead of several days) with a plurality of remote bidders. In other words, the auction is generally performed when several bidders are viewing a bidder interface for an auction item at the same time.

Preferably, the auction system 100 includes a media server 116, a database server 118, and a web server 120, which may be separate servers or may be virtualized on one or more physical servers. The media server 116 preferably accepts images, video and/or audio from a first location 102 via camera 104 of auction item 106. For example, a seller may take a picture of an auction item, log on to a seller interface on webpage 122, and cause the auction item's image to be stored on media server 116. The media server 116 also accepts images, video, and/or audio of the auctioneer 112 via camera 110, occurring at the same location 102 as the item 106 or a different location 108. For example, the main camera 110 may record video of the auctioneer 112 to the server 116 during an auction, which is then displayable in webpage 122 when viewed by a bidder 124.

The auction software on the web server 120 serves up web pages to the auctioneer 112 (as a control interface for controlling the progression of the auction) and to the registered auction bidders for interacting with one or more auctions. The web server 120 also accesses and stores auction data on data server 118 (e.g., bid data, usernames, passwords, account information, auction item data, etc.). The auction web page 122 is generally served by the web server 120. Images, video, and audio from the media server 116 are preferably downloaded or streamed by the bidders 124 directly via the code of the web page 122 (e.g., the downloaded webpage provides embedded media from the media server's address).

The auctioneer 112 preferably conducts the auction via a computing device such as tablet 114, which sends and receives data with web server 120. Preferably, the computing devices used by the auctioneer, bidders, and sellers all include a processor that can execute code or other instructions, communicate over a LAN/WAN, a display that can display a graphical user interface, and at least one input device, such as a touch screen, mouse, or keyboard. Each of these computing devices can utilize a web browser to view the auction software's graphical user interfaces or can utilize a stand-alone application.

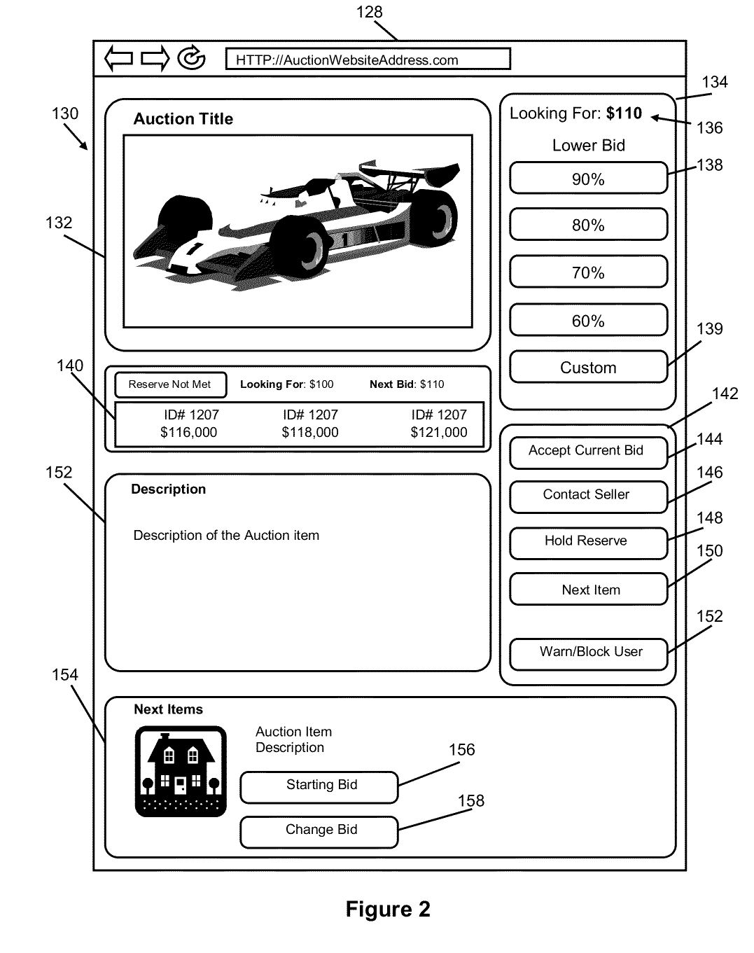

FIG. 2 illustrates an example auctioneer interface 130 that is displayed in a web browser 128 or a standalone application and used by the auctioneer to administer the auction. The auctioneer interface 130 includes a media region 132 that can display images, video, and/or audio relating to the auction item (e.g., from media server 116). The media region 132 may also optionally display images, video, and/or audio of the auctioneer 112, allowing the auctioneer 112 to either select (e.g., via a section button element) between viewing media of the auction item, the auctioneer, or a split screen of both.

The auctioneer interface 130 also includes a streaming bid display region 140, which provides a unique bidder identification (associated with a bidder's user account), such as a bidder ID number or username, that is positioned adjacent to a bid level for an auction item. For example, the bid level may be located above, below or to the side of the auction item identification. Preferably, the current, highest bid level and the associated bidder ID is displayed in this region 140, along with several of the previous bids. Additionally, this display region 140 may include images and video, and can be dynamically expandable, depending on the size of the text, images, and video. The information in the streaming bid display region 140 may move sideways (e.g., left to right), may remain stationary, and/or may move only during the addition of new information (e.g., addition of a new, highest bid). In this respect, the auctioneer can easily view the current bid level for an auction item, as well as several previous bid levels.

A description of the current auction item is displayed in the auction description area 152, which is preferably located below a streaming bid display region 140. The description within this area is preferably a text description that has been previously entered by the auctioneer or seller creating the auction and is stored on the database server 118.

The auctioneer interface 130 also includes an auction preview region 154 that is preferably located along a bottom of the interface 130. The auction preview region 154 preferably provides the auctioneer with information relating to upcoming auctions, such as an auction item image and text description. Additionally, this region 154 preferably includes a starting bid button element 156, which, when pressed, allows the auctioneer to enter a starting or asking bid for that upcoming auction. Additionally, a change bid button element 158 is also included, allowing an auctioneer to modify a previously entered starting or asking bid for the upcoming auction.

In a typical auction, the auctioneer may start bidding off at a relatively high value and then supply progressively lower suggested bid values until a bidder makes or accepts a suggested bid. This process is sometimes known as determining the “floor” or lowest bid level for auction bidding to start at. Preferably, the present invention includes an interface for assisting the auctioneer 112 in determining the bid floor. FIG. 2 illustrates an auction floor interface 134 displayed on the auctioneer interface 130 (though this interface may initially be displayed on its own at the beginning of an auction). The interface 134 preferably includes a plurality of suggested bid button elements 138 that, when selected, determine a reduction in the asking bid amount which is then transmitted to the interfaces of each of the bidders. Preferably, the elements 138 are labeled with percentages, each of which is progressively lower than the element 138 above it (e.g., each element 138 is below 100% and decreases in either 5% or 10% increments). When clicked or selected, the element 138 causes the auction software to reduce the opening asking bid by its displayed percentage (i.e., a lower opening bid or asking bid is transmitted out to and displayed on the bidder's webpage 122). For example, a “90%” element 138 reduces a $100 suggested bid to $90. When the auctioneer 112 clicks or selects either a certain number of elements 138 (e.g., four element 138) or a certain element 138 towards the bottom of the interface 1834 (e.g., the fourth element 138 down), the interface 134 dynamically repopulates the elements 138 with progressively lower percentage values, thereby allowing the auctioneer 112 to further reduce the suggested bid level (shown in element 136), if necessary. Additionally, the last button element 139 is preferably a “custom” element that, when selected, displays a numerical input box for allowing the auctioneer 112 to input a custom suggested bid.

Once a first bid from a bidder 124 is submitted, the auctioneer interface 130 automatically displays the current, highest bid in the streaming bid display region 140. As new highest bids are received, the streaming bid display region 140 maintains a list of several of the most recent bids, with the highest and currently winning bid sorted and/or highlighted at either the left or right of the streaming display. Preferably, each bid in the list is accompanied by the respective bidder ID of the bidder 124 that made the bid (i.e., a unique identifier associated with a bidder's account). In this respect, the auctioneer 112 can view the display region 140 during an auction and appropriately monitor the highest bid.

The auctioneer interface 130 also includes an action interface selection area 142 which provides several different interface elements that allow the auctioneer 112 to control various other aspects of the auction. For example, the selection area 142 may include an accept current bid button element 144 which, when selected, causes the auction software to accept the current highest bid and end the auction, thereby awarding the auction item to the highest bidder.

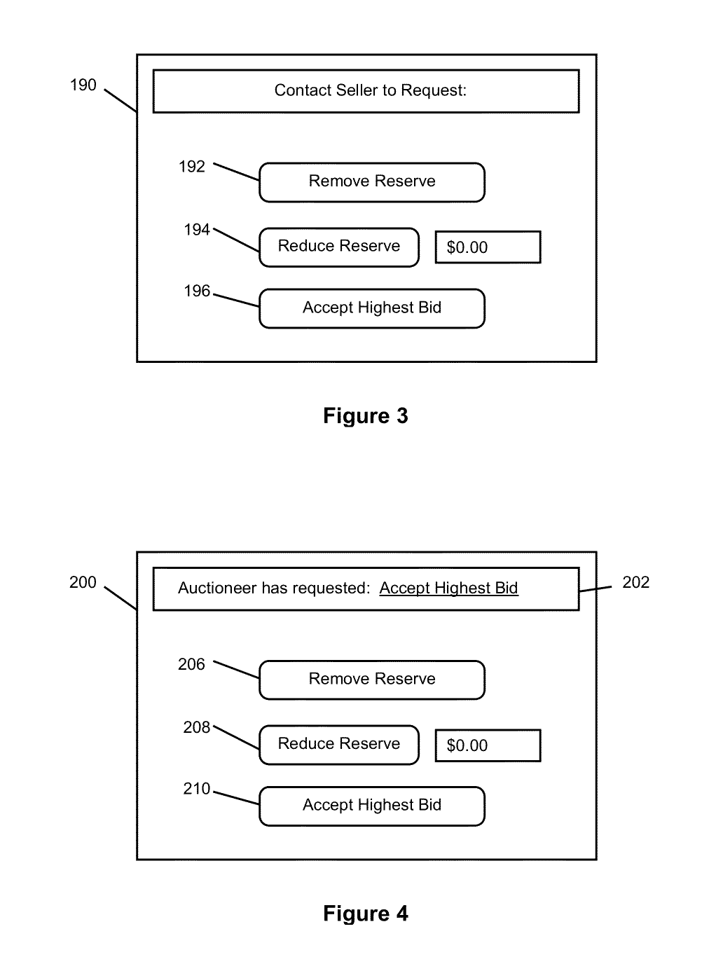

In another example, the selection area 142 may include a contact seller button element 146 for allowing the auctioneer 112 to contact the seller during an auction. If this button element 146 is selected by the auctioneer 112 when the current auction bid is lower than the auction item's reserve price, a contact seller interface 190 is displayed, as shown in FIG. 3. The interface 190 (preferably a popup window) includes a plurality of button elements that, when clicked or selected, send a message to the auction seller. For example, the interface 190 includes a remove reserve button element 192 for requesting that the auction's reserve be removed, a reduce reserve button element 194 and accompanying text box for requesting that the auction's reserve be reduced to a specific amount, and/or an accept highest bid button element 196 for requesting that the highest current bid be accepted to end the auction.

Once one of these button elements 192, 194, and 196 are clicked or selected, the web server 120 contacts the seller (if they are not already on the auction's website), and provides them a link (e.g., via email, SMS, or popup notification from the website 122) to seller auction interface 200, shown in FIG. 4. The seller auction interface 200 provides an information display element 202 that display's the auctioneer's request to the seller (e.g., one of the button elements 192, 194, and 196). The seller can respond to the bidder's request by clicking or selecting one of several responses, such as a remove reserve button element 206 to remove the auction's reserve, a reduce reserve button element 208 and accompanying text box to reduce the reserve to a specific level, an accept highest bid button element 210 to accept the highest current bid, even if it is below the current reserve of the auction item.

If the contact seller button element 146 is selected by the auctioneer 112 when the current auction bid is higher than the auction item's reserve price or for an item without a reserve price, the highest bid by a bidder 124 is accepted, thereby completing the auction. Hence, the contact seller button element 146 can provide another mechanism for an auctioneer 112 to complete an auction.

Returning to the action interface selection area 142 in FIG. 2, a hold reserve button element 148 is also available for the auctioneer to remove the reserve for the auction item. A next item button element 150 advances the auctioneer interface 130 to the next item in line for auction, and the warn/block user button interface 152 allows the auctioneer to notify warn or block a user from an auction if they are causing problems.

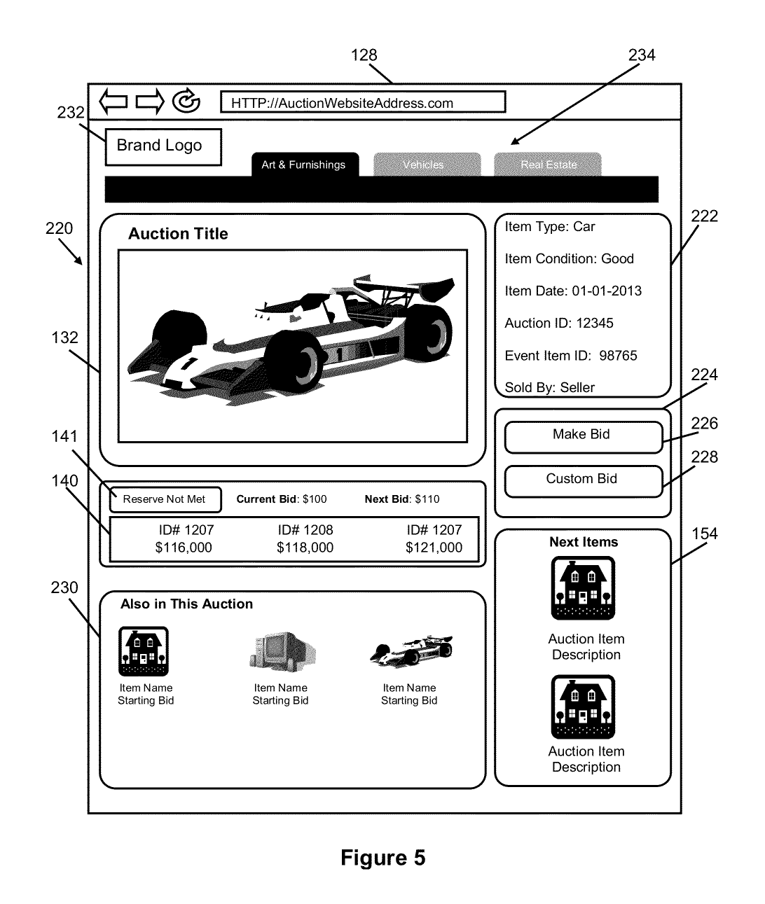

Turning to FIG. 5, a bidder interface 220 is shown for display in a web browser 129 or a standalone application. The bidder interface 220 includes many of the same or similar interfaces as described for the auctioneer interface 130, such as the media region 132, the streaming bid region 140, and the auction preview region 154. Additionally, the bidder interface 220 includes an auction item summary 222 which includes important information about the current auction item, such as they item type, item condition, item date, auction ID, event item ID, and the name of the seller.

Typically, a single auction event may auction several different items (e.g., several different types of cars). The auction item area 230 displays one or more of the other items, in addition to the currently auctioned item, that are also being auctioned as part of the current auction event. In this respect, the bidder 124 may be alerted to other auction items that may have some similarity to the present auction item.

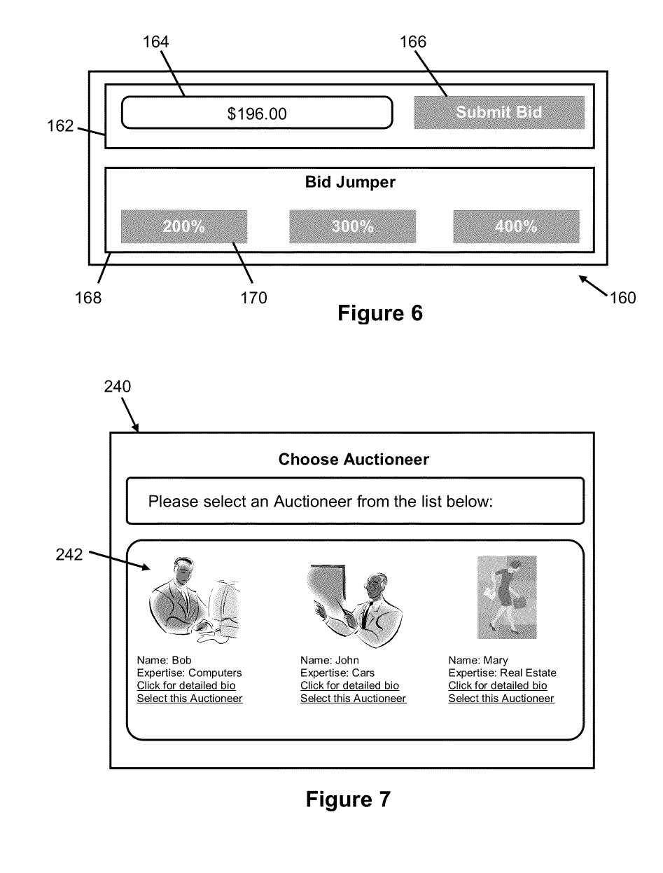

Bidder action area 224 provides two main action button elements for the bidder to use during an auction: a make bid button element 226 and a custom bid button element 228. By selecting or clicking the make bid button element 226, the bidder accepts the next or asking bid (e.g., as shown in the streaming bid region 140). However, if the bidder wishes to make a bid that is different than the next bid, the custom bid button element 228 can be selected. This element 228 displays a window with a custom bid entry interface 160, as seen in FIG. 6. In a top region 162, a text box 164 is displayed, allowing a user to enter an exact bid amount, which is submitted by selecting or pressing the submit bid button element 166. The auction software will round the entered number to the nearest bid increment previously determined by the auctioneer. For example, if the Auctioneer previously determined that all bid increments will be in 10% increments, the custom bid will be rounded up or down to the nearest 10% increment.

The custom bid entry interface 160 also includes a bottom region 168 or bid jumper region that provides a plurality of predetermined bid increase button elements 170. The bid increase button elements 170 preferably have either bid increase percentages or an actual bid increase amount displayed on or near the elements 170. In this regard, a user can increase the amount of their next bid by a predetermined percentage. For example, if the auctioneer is looking for a next bid that increases the total bid price by $10, a 200% bid increase button element 170 will submit a bid of $20. Hence, determined bidders can more quickly increase the total bid price.

Returning to FIG. 5, the bidder interface preferably includes a plurality of navigation tabs 234 with general auction item categories. Selecting one of these tabs presents the user with a list of upcoming auction items in that particular category.

The bidder interface 220 can also be customized or branded by a seller for a particular auction item. For example, a seller's interface can allow the seller can upload one or more images of a brand logo in connection with an auction item. This logo or image can be displayed in various locations, such as the background of the bidder interface 220 and/or area 232.

The bidder interface 220 also preferably includes an indicator 141, that indicates if the reserve of an auction item has been met. For example, the indicator may state “reserve not met” or “reserve met” as appropriate during an auction. In some cases, a seller may wish to disclose the reserve price, which would be displayed in the indicator 141. For example, the indicator 141 may state “reserve of $100 not met”. In other cases, the reserve level may not be explicitly disclosed, but may instead be estimated for a bidder by color. For example, when a highest bid is low and therefore far from a reserve price, the indicator 141 may be red. As the highest bid level increases towards the reserve level (e.g., within 10% of the reserve level), it may turn orange and then, finally green when the reserve has been met.

In one aspect of the present invention, an auctioneer selection interface 240 is provided to a seller as part of setting up the auction of their item, as seen in FIG. 7. The interface 240 provides an auctioneer selection area 242 that provides a description and selection link for one or more auctioneers. For example, the area 242 includes media of an auctioneer (e.g., an image, video, or audio of an auctioneer performing an example auction), the auctioneer's name, the auctioneer's expertise, a link for a detailed auctioneer biography, and a link or button to select a specific auctioneer to auction the seller's item. In this respect, the seller can have more control over how their item is auctioned.

In one aspect of the present invention, web page 122 provides an absentee bidding input interface that allows a potential bidder to input an absentee bid level. The auction software will, in turn, incrementally submit bids in minimal amounts during an auction up until the bidder wins the auction or until the absentee bid level is met. If an auction has automatic absentee bidders, the software will automatically start bidding at the reserve amount (assuming the absentee bid level has been set above the reserve price) and then proceed with automatically and incrementally submitting bids at predetermined intervals (e.g., every 10 seconds) and at minimal bid increments determined by the auctioneer's asking bid. This interval allows the auctioneer time to solicit bids from live bidders 124. Preferably, if an absentee bidder logs into the auction software via webpage 122, the bidder will be presented with an interface display that notifies the bidder that the auction is currently underway and whether the bidder would like to shutdown absentee bidding in favor of live bidding that is directly controlled by the bidder. In other words, the bidder is provided an option to manually override automatic bidding by the auction software.

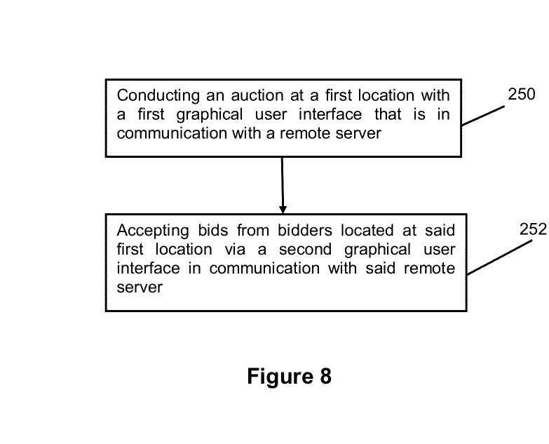

In one aspect of the present invention, the bidders 124 and auctioneer 112 can all be located at a single, physical location and can each access the variously described interfaces via mobile tablets, phones, or laptops. In this respect, various events, such as charity events, can have a live, in-person auction that proceeds similar to a traditional, in person auction but that utilizes the previously described auction software for administering the auction, bidding and performing other auction functions. Hence, as shown in FIG. 8, this aspect include the method of conducting an auction at a first location with a first graphical user interface that is in communication with a remote server (element 250) and Accepting bids from bidders located at said first location via a second graphical user interface in communication with said remote server (element 252).

In another aspect of the present invention, the previously described auction software can be used in connection with other media, such as TV or radio. For example, a TV personality on a TV program may act as the auctioneer 112 and conduct the auction while viewers log onto the auction webpage 122 and bid on the auction.

It should be understood that the terms clicked or selected have been used in connection with various graphical elements of the auction interface, but can also mean touched, engaged, activated, or otherwise actively chosen by a user. This selection may be via a hand for touch interfaces or via a mouse/keyboard for non-touch interfaces. In one aspect of the present invention, inputs of the various interfaces can be performed via speech recognition, allowing auctioneers and bidders to rely on voice commands to navigate and interact with the previously described interfaces.

It should also be understood that the present invention includes methods of performing an auction that include displaying and interfacing with any of the previously described interfaces and/or interface elements.

Although the invention has been described in terms of particular embodiments and applications, one of ordinary skill in the art, in light of this teaching, can generate additional embodiments and modifications without departing from the spirit of or exceeding the scope of the claimed invention. Accordingly, it is to be understood that the drawings and descriptions herein are proffered by way of example to facilitate comprehension of the invention and should not be construed to limit the scope thereof.

What is claimed is:

1. A computer readable storage medium storing one or more programs, the one or more programs comprising instructions that, when rendered on a remote computing device, cause the device to:
display a graphical user interface having a plurality of graphical elements that each control administration of a live, online auction.

2. A graphical user interface on a computing device having a display and an input, the graphical user interface comprising:
a plurality of graphical elements that control bidding during a live, online auction.

3. A method of performing an auction, comprising:
conducting an auction at a first location with a first graphical user interface that is in communication with a remote server;
accepting bids from bidders located at said first location via a second graphical user interface in communication with said remote server.
